(19) United States
(12) Patent Application Publication
(10) Pub. No.: US 2009/0273686 A1
(43) Pub. Date: Nov. 5, 2009

(54) Methods, computer program products and apparatus providing improved image capturing

(75) Inventors: Timo Kaikumaa, Nokia (FI); Ossi Kalevo, Toijala (FI); Martti Ilmoniemi, Tampere (FI); Rolf Boden, London (GB); Sin-Hung Yong, Fleet (GB); Andrew Baxter, Newbury (GB)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/150,966

(22) Filed: May 2, 2008

(51) Int. Cl. H04N 5/228

(52) U.S. Cl. 348/222.1; 348/E05.024

(57) ABSTRACT

The exemplary embodiments of the invention allow for parallel operations within a digital image capturing system. For example, raw image data can be processed while a subsequent image is being captured. In one exemplary embodiment of the invention, a method includes: executing at least one foreground operation within a digital image capturing device; and executing at least one background operation within the digital image capturing device, wherein the at least one foreground operation includes: capturing raw image data via at least one sensor, storing the captured raw image data as an intermediate file, and activating a digital viewfinder, wherein the at least one background operation includes: accessing the intermediate file, performing image processing on the raw image data of the intermediate file to obtain processed image data, and storing the processed image data, wherein the at least one background operation is executed independently of the at least one foreground operation.

### TECHNICAL FIELD

The exemplary and non-limiting embodiments of this invention relate generally to image capture devices or components and, more specifically, relate to digital image capturing.

### BACKGROUND

The following abbreviations are utilized herein:
CCD charge-coupled device
CF compact flash
CMOS complementary metal-oxide-semiconductor
CPU central processing unit
DMA direct memory access
DPCM differential pulse code modulation
DSP digital signal processor
GIF graphics interchange format
HW hardware
HWA hardware accelerator
ISP image signal processor
JPEG joint photographic experts group
MMS multimedia message service
PCM pulse code modulation
PDA personal digital assistant
RAM random access memory
RF radio frequency
SW software
UI user interface
VF viewfinder

Digital camera systems, such as those in mobile phones, can use HW ISPs, HWAs or SW-based image processing. Generally, HW-based solutions process images faster than SW-based counterparts, but are more expensive and less flexible.

During digital still image camera picture-taking, a number of sequential processing steps are performed in order to produce the final image. For example, these steps may include: extracting the raw image data from the camera sensor HW into memory, processing the raw image (e.g., interpolating, scaling, cropping, white balancing, rotating), converting the raw image into intermediate formats for display or further processing (e.g., formats such as RGB or YUV), compressing the image into storage formats (e.g., formats such as JPEG or GIF), and saving the image to non-volatile memory (e.g., a file system). These operations are performed in a sequential manner such that a new image cannot be captured until the operations are completed. The time delay associated with these sequential processing steps plus the time delay in reactivating the digital viewfinder so that the user can take the next picture is referred to as the “shot-to-shot time.”

FIG. 1 illustrates a diagram 100 of the sequential operations performed by a conventional sequential image capturing system. At step 101, a camera sensor produces raw data. The raw image data is extracted from the camera sensor HW into memory (e.g., volatile memory). At step 102, the raw data is processed by an image processing component which generates a processed image. At step 103, the processed image is converted to an intermediate format for display or further processing. At step 104, the resulting image is compressed into a storage format. At step 105, the compressed image is stored to non-volatile memory. At step 106, the digital viewfinder is reactivated. As can be seen in FIG. 1, in order for the digital viewfinder to reactivate (step 106) after a picture has been taken (step 101), steps 102-105 must first be performed.

Camera sensor resolutions (e.g., in mobile phones and terminals) are increasing. At the same time, image processing is being moved from dedicated HW into SW in order to reduce costs. This is generally putting a greater load on image processing (e.g., the CPU) and memory performance (e.g., memory size and/or speed). As a result, the length of time to take a picture is generally increasing. That is, users may experience a delay between pressing the camera capture button and being able to subsequently access menus or to take a subsequent picture, due to processing and saving of the image.

With a SW-based solution, sequential processing is generally inefficient and, from the user's point-of-view, it is not tolerable to wait a length of time (e.g., 30 seconds) to capture another image or image burst or have the viewfinder running again (e.g., displaying a preview).

Some conventional cameras utilize a burst-mode to capture many images in a rapid manner. In burst-mode, the raw images are stored into a buffer memory and processed from there. For example, if a camera with a 5-image buffer memory is used, one can take 5 images rapidly but there is a delay when taking the 6th image since one needs to wait until all raw images have been processed and enough buffer memory has been released for a new raw image.

One prior art approach describes a method and digital camera that seek to provide a reduced delay between picture-taking opportunities. See U.S. Pat. No. 6,963,374 to Nakamura et al. This approach uses parallel HW processing to provide processing of up to two images at any one time (see, e.g., FIGS. 7 and 8 of Nakamura et al.). The approach relies on each processing step to be completed in a critical time and provides images only in a final JPEG format. Furthermore, during power-off this approach completes processing of an unprocessed image.

Another prior art approach describes apparatus and methods for increasing a digital camera image capture rate by delaying image processing. See U.S. Reissue Pat. No. RE39213 to Anderson et al. In this approach, images are processed in the order they are captured. The final output is only available as a JPEG and background processing is always used.

### SUMMARY

In one exemplary embodiment of the invention, a method comprising: executing at least one foreground operation within a digital image capturing device, wherein the at least one foreground operation comprises: capturing raw image data via at least one sensor, storing the captured raw image data as an intermediate file, and activating a digital viewfinder; and executing at least one background operation within the digital image capturing device, wherein the at least one background operation comprises: accessing the intermediate file, performing image processing on the raw image data of the intermediate file to obtain processed image data, and storing the processed image data, wherein the at least one background operation is executed independently of the at least one foreground operation.

In another exemplary embodiment, a program storage device readable by a machine, tangibly embodying a program of instructions executable by the machine for performing operations, said operations comprising: executing at least one foreground operation within a digital image capturing device, wherein the at least one foreground operation comprises: capturing raw image data via at least one sensor, storing the captured raw image data as an intermediate file, and activating a digital viewfinder; and executing at least one background operation within the digital image capturing device, wherein the at least one background operation comprises: accessing the intermediate file, performing image processing on the raw image data of the intermediate file to obtain processed image data, and storing the processed image data, wherein the at least one background operation is executed independently of the at least one foreground operation.

In another exemplary embodiment, an apparatus comprising: at least one sensor configured to capture raw image data; a first memory configured to store the raw image data; a display configured to display at least one of a preview image for the raw image data or a viewfinder image; an image processor configured to process the stored raw image data to obtain processed image data; and a second memory configured to store the processed image data, wherein the image processor is configured to operate independently of the at least one sensor and the display.

### BRIEF DESCRIPTION OF THE DRAWINGS

The foregoing and other aspects of exemplary embodiments of this invention are made more evident in the following Detailed Description, when read in conjunction with the attached Drawing Figures, wherein:

FIG. 1 illustrates a diagram of the sequential operations performed by a conventional sequential image capturing system;

FIG. 2 illustrates a block diagram for the dual-stage operation of exemplary processes in a digital image capturing system in accordance with the exemplary embodiments of the invention;

FIG. 3 shows a diagram of the components and control paths in an exemplary device (a camera) in accordance with aspects of the exemplary embodiments of the invention;

FIG. 4 shows a further exemplary camera incorporating features of the exemplary camera shown in FIG. 3;

FIGS. 5A and 5B depict a flow diagram illustrating exemplary processes relating to an image queue and background processing for a camera in accordance with exemplary embodiments of the invention;

FIG. 6 depicts a flow diagram illustrating exemplary processes relating to a pause feature that may be implemented for a camera in accordance with exemplary embodiments of the invention;

FIG. 7 illustrates a simplified block diagram of an electronic device that is suitable for use in practicing the exemplary embodiments of this invention;

FIG. 8 depicts hardware and software interactions for an exemplary image capturing system 300 in accordance with exemplary embodiments of the invention;

FIG. 9 depicts a flowchart illustrating one non-limiting example of a method for practicing the exemplary embodiments of this invention;

FIG. 10 depicts a flowchart illustrating another non-limiting example of a method for practicing the exemplary embodiments of this invention;

FIG. 11 depicts a flowchart illustrating another non-limiting example of a method for practicing the exemplary embodiments of this invention; and

FIG. 12 depicts a flowchart illustrating another non-limiting example of a method for practicing the exemplary embodiments of this invention.

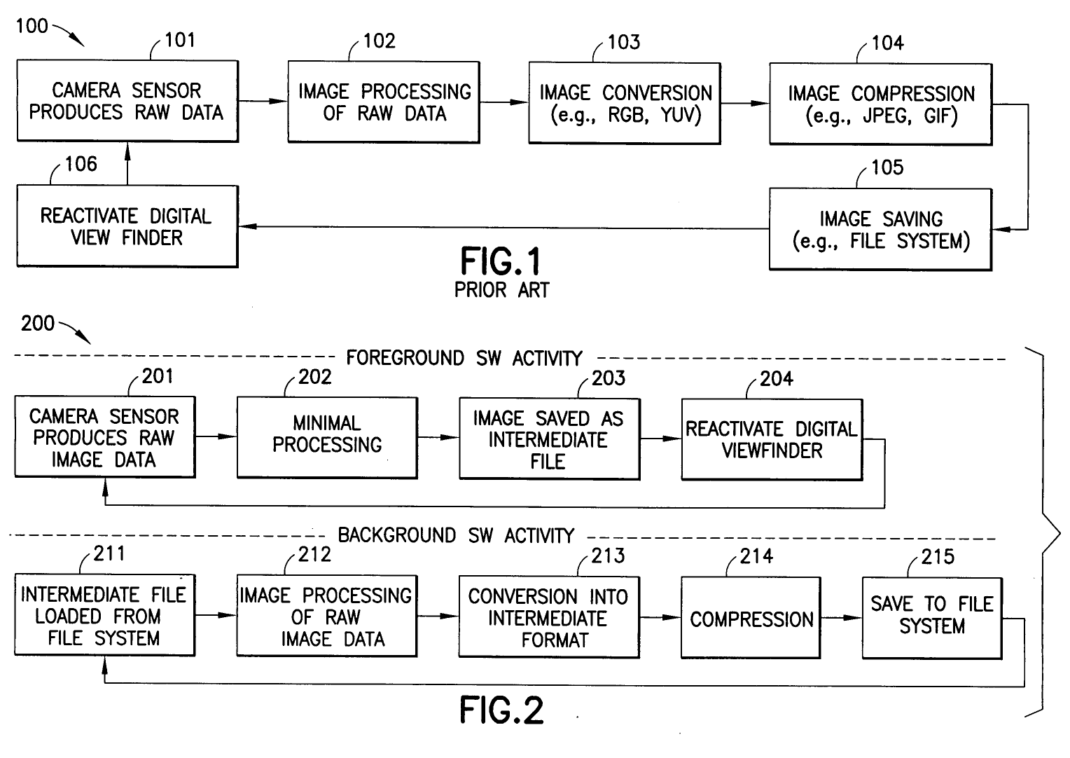

### DETAILED DESCRIPTION

Digital photography uses an array of pixels (e.g., photodiodes) along the sensing surface. A CCD is commonly used as the device on which the image is captured, though others, such as complementary metal-oxide semiconductor CMOS sensors, may be used without departing from the teachings herein. Digital cameras, whether enabled for video or only still photography, may be stand-alone devices or may be incorporated in other handheld portable devices such as cellular telephones, personal digital assistants, BlackBerry® type devices, and others. Incorporating them into devices that enable two-way communications (e.g., mobile stations) offer the advantage of emailing photos or video clips via the Internet. Increasingly, digital cameras may take still photos or video, the length of the video that may be recorded generally limited by available memory in which to store it. If desired, the current invention can also be applied to non-portable imaging or camera devices.

One conventional camera, the Nikon® D70, buffers the raw image data and converted output data by temporarily storing them in a buffer before being written to a CF card. The camera stores the unprocessed, raw data in the buffer as it is provided by the image sensor. The unprocessed data is then converted to an image file format (i.e., image processing is performed) which is also temporarily stored in the buffer. The image file is written from the buffer to the CF card. Note that the operations of converting the unprocessed data and writing the image file to the CF card can occur in parallel. Thus, the image processing and writing operations are constantly freeing buffer space for new shots to be stored. As such, a user does not have to wait for the entire burst of frames to be written to the CF card before there is enough space to take another burst. The dynamic buffer enables a user to capture up to 144 pictures in sequence with no buffer stall, using selected CF cards. Further note that while the operations of converting the unprocessed data and writing the image file to the CF card can occur in parallel, they are interdependent and cannot function independently from one another without significantly affecting the overall efficiency and speed of the image capture process.

The Nikon® D70 has an optical viewfinder. This means that viewfinder images are not processed at all in the Nikon® D70. Instead, the viewfinder image comes through the lens using mirrors and/or prisms to provide light to the viewfinder and also to an image sensor which is used only to capture still images. The Nikon® D70 approach does not provide still image processing in parallel with a viewfinder image or preview image processing.

The exemplary embodiments provide various improvements over prior art image capturing systems by separating the image capture process into at least two independent stages or sets of processes, referred to below as foreground processes and background processes. The foreground and background processes are configured to execute independently of one another. As non-limiting examples, the foreground processes may comprise those processes specifically relating to image capture (e.g., capturing of raw image data and storage of raw image data as an intermediate file) and digital viewfinder operations (e.g., capturing, processing and display of viewfinder images; display of preview images for the raw image data, the intermediate file and/or the processed image data). As a non-limiting example, the background processes may comprise those processes relating to image processing (e.g., retrieval of raw image data from storage, performing image processing on the raw image data to obtain processed image data, storage of the processed image data). In such a fashion, image capturing speed is improved since images are processed separately from the capture and storage of raw image data.

Each of the independent stages is capable of performing its operations substantially separately (independently) from the operations of other stages. Separating the various processes into a plurality of stages may enable rapid re-initialization of the viewfinder such that a user can see a viewfinder image (i.e., for subsequent image capturing) or preview image (i.e., for one or more captured images) soon after image capture (e.g., taking a picture). Furthermore, subsequent images may be captured before one or more earlier captured images have been processed. In further exemplary embodiments, the image can be viewed (e.g., from an image gallery) by using the stored raw image data (i.e., the intermediate file), even before the image has been processed.

Note that while the stages are described herein as independent from one another, it should be appreciated that the stages are generally not entirely separated, but rather that the operations in the stages are not performed in a strictly sequential manner and can provide parallel performance of multiple operations (e.g., simultaneous but separate image capturing and processing of captured images). The use of an intermediate file that stores at least the raw image data enables subsequent access to and manipulation (e.g., image processing) of the raw image data. Furthermore, since the image processing is now removed (e.g., separate, independent) from the image capture process, the image capture process will not be affected by the delays inherent in the image processing.

For convenience, the below discussion will assume that only two independent stages are used, herein referred to as a foreground stage (for foreground processes) and a background stage (for background processes). It should be appreciated that any suitable number of stages may be utilized. The number of stages employed may be based on the desired operations, hardware considerations and/or software considerations, as non-limiting examples.

For the purposes of the below discussion, foreground processes may be considered those operations that directly affect the shot-to-shot time of the image capturing process. For example, the image capturing and storage operations are in the foreground since they directly affect the shot-to-shot time. Similarly, the viewfinder operation (i.e., for a digital viewfinder) is also in the foreground since viewfinder re-initialization is generally required in order to take each subsequent shot. In contrast, and as a non-limiting example, for the exemplary embodiments of the invention, image processing is generally located in the background stage since image processing is performed independently from image capture and does not affect shot-to-shot time.

FIG. 2 illustrates a block diagram 200 for the dual-stage operation of exemplary processes in a digital image capturing system in accordance with the exemplary embodiments of the invention. The processes are separated into two independent stages: foreground SW activity (operations 201-204) and background SW activity (operations 211-215). As noted above, the foreground and background stages are independent from one another such that either stage may perform its processes separately from the other stage.

The foreground SW activity comprises the following processes. In 201, a camera sensor produces raw image data (e.g., in response to a user pressing the image capture button). In 202, minimal processing is performed on the raw image data and the result is stored as an intermediate file (e.g., in a file system, memory buffer or other storage medium) (203). In 204, the digital viewfinder is reactivated, enabling a user to capture a second image (returning to 201). In further exemplary embodiments, the foreground SW activity may further comprise displaying a preview image for the captured image. The preview image may be based on the raw image data and/or the intermediate file, as non-limiting examples.

The background SW activity comprises the following processes. In 211, the intermediate file containing the raw image data is loaded from the file system. In 212, image processing is performed on the raw image data to obtain processed image data. In 213, the image is converted into an intermediate format, such as RGB or YUV, as non-limiting examples. In 214, the result is compressed into another format, such as GIF or JPEG, as non-limiting examples. In 215, the result is saved to the file system as the final, processed image (“processed image data”). The background SW activity then returns to 211 for further processing of other unprocessed images (unprocessed intermediate files comprising unprocessed raw image data).

While shown in FIG. 2 as separate steps or boxes, it should be noted that two or more of the steps described in 212, 213 and 214 may be performed concurrently by a component or components. For example, in some exemplary embodiments, the conversion 213 instead may be considered as one function performed during the image processing 212 of the raw image data.

Relatedly, in some exemplary embodiments, pre-processing steps may be performed on the raw image data in the foreground prior to the intermediate file being saved. In some exemplary embodiments, execution of such pre-processing steps may be conditional, for example, depending on processor load, processor speed, storage speed and/or storage capacity. Generally, it may be desirable to keep such pre-processing at a relative minimum in order to prevent the accumulation of additional delays in the foreground activities (i.e., since such pre-processing would be performed at the expense of potentially delaying reactivation of the digital viewfinder). In some exemplary embodiments, such pre-processing is not performed in the foreground but rather as part of the background operations.

In some exemplary embodiments, at least one of the foreground processes is performed by at least one first processor and at least one of the background processes is performed by at least one second processor (i.e., one or more processors different from the at least one first processor). In other exemplary embodiments, at least one of the foreground processes and at least one of the background processes are performed by at least one same processor (e.g., one processor performs a multitude of processes, including at least one foreground process and at least one background process). The choice of whether to implement a multi-processor architecture, a single gated (e.g., time-sharing) processor, or a single multi-operation (e.g., multi-core) processor may be based on one or more considerations, such as cost, performance and/or power consumption, as non-limiting examples.

In some exemplary embodiments, it may be desirable to selectively execute foreground operations and/or background operations. For example, in some situations it may be desirable to activate foreground/background processes while substantially simultaneously deactivating background/foreground processes. The decision of whether or not to implement foreground processes, background processes or both foreground and background processes may be based on consideration of one or more factors. As non-limiting examples, such a determination may be based on one or more of: the application/processes in question (e.g., whether or not the application can support foreground and background processes), storage speed (e.g., memory write speed), a comparison of image processing time and storage speed, available storage space, processor performance, and/or processor availability.

In further exemplary embodiments of the invention, the processing of images in the background stage is performed in response to one or more conditions being met. For example, the raw image data may be processed when there are unfinished images available (i.e., to process). As another example, the raw image data may be processed when there are unfinished images available and the image capture device has been turned off (e.g., powered down) or a certain amount of time has lapsed without further image capturing or user operation (e.g., user-directed image processing, user-initiated viewing of preview images).

In some exemplary embodiments, the various processes of the foreground and background stages execute based on relative priority. As a non-limiting example, foreground processes may have higher priority than background processes. As a further non-limiting example, the SW may disallow execution of one or more background processes while one or more foreground processes are currently being executed. This may be useful, for example, in managing processor usage, processor efficiency, processor speed, storage speed (e.g., memory read or memory write operations) and/or power consumption. As a further non-limiting example, image processing may be disallowed until the image capturing device is turned off or powered down.

Although described in the above exemplary embodiments with respect to one or more file systems, in other exemplary embodiments the intermediate file may be saved, temporarily or permanently, to any suitable storage medium, such as volatile (e.g., RAM) and/or non-volatile (e.g., a file system, flash memory) memory, as non-limiting examples. Similarly, the processed image file (comprising at least the processed image data) may be saved, temporarily or permanently, to any suitable storage medium, such as volatile and/or non-volatile memory, as non-limiting examples. One or both of the intermediate file and the processed image file may be saved, temporarily or permanently, to an internal memory (e.g., RAM, a separate internal memory or other internal storage medium) and/or a memory external to or attached to the device (e.g., removable memory, a flash card, a memory card, an attached hard drive, an attached storage device).

As noted above, the intermediate file comprises at least the raw image data. In further exemplary embodiments, the intermediate file comprises additional information and/or data concerning the captured image and/or the raw image data. As a non-limiting example, the intermediate file may comprise a preview image for the captured image corresponding to the raw image data. In such a manner, the preview image can easily be viewed (e.g., have the preview image shown on the display) by a user. As another non-limiting example, processing parameters may be stored in the intermediate file. Such stored processing parameters can be updated at a later time. As a non-limiting example, the raw image data stored in the intermediate file may comprise lossless or substantially lossless image data. In further exemplary embodiments, the intermediate file may also store the processed image data in addition to the raw image data.

In further exemplary embodiments, the intermediate file may be used for additional operations or functions (i.e., beyond storage of raw image data and accessing for image processing). For example, in some cases the intermediate file may be considered as an uncompressed image file (e.g., similar to a BMP) and can be easily accessed, viewed, transferred and zoomed so that the SW can still offer various imaging features for the unprocessed image, even as it provides for the final saved JPEG images (e.g., performs image processing on the raw image data).

The use of an intermediate file to store raw image data (e.g., for background processing) provides a very flexible solution. It can be stored in different memory types and/or easily moved between memory types. It can also offer imaging application features that the final image offers, such as those noted above. In addition, in some exemplary embodiments, this file can be exported to a computer or other device to be processed using more intensive image processing algorithms which may not be available on the image capture device (e.g., due to limited resources). If the format of this file is published, then there is potential for popular third party software developers to include the relevant decoder in their applications. Furthermore, and as a non-limiting example of one potential application for the file so noted above, the device can include a raw (Bayer) image viewer application that enables viewing of a preview image based on the stored raw data file. In other exemplary embodiments, the format of the intermediate file may comprise a proprietary format.

It should be noted that raw image data is usually referred to as Bayer data. Raw Bayer data files are generally smaller than true bitmap files but much larger than compressed JPEG files. However, raw Bayer data may be lossless or substantially lossless (e.g., DPCM/PCM coded) and generally represents the purest form of the image data captured by a HW sensor. Hence, this image data can be manipulated, for example, with many sophisticated algorithms.

In one non-limiting, exemplary embodiment, the camera application SW comprises at least three components: a UI, an engine and an image processor. The three component may run in one or more operating system processes. Furthermore, the three components may operate separately or concurrently. The three components may be run in one or more processors, as noted above, and/or other elements (e.g., circuits, integrated circuits, application specific integrated circuits, chips, chipsets). In accordance with the above-described exemplary embodiments, the UI and engine generally operate in the foreground stage while the image processor generally operates in the background stage. Also as mentioned above, two or more of the three components may operate in parallel (i.e., at a same time).

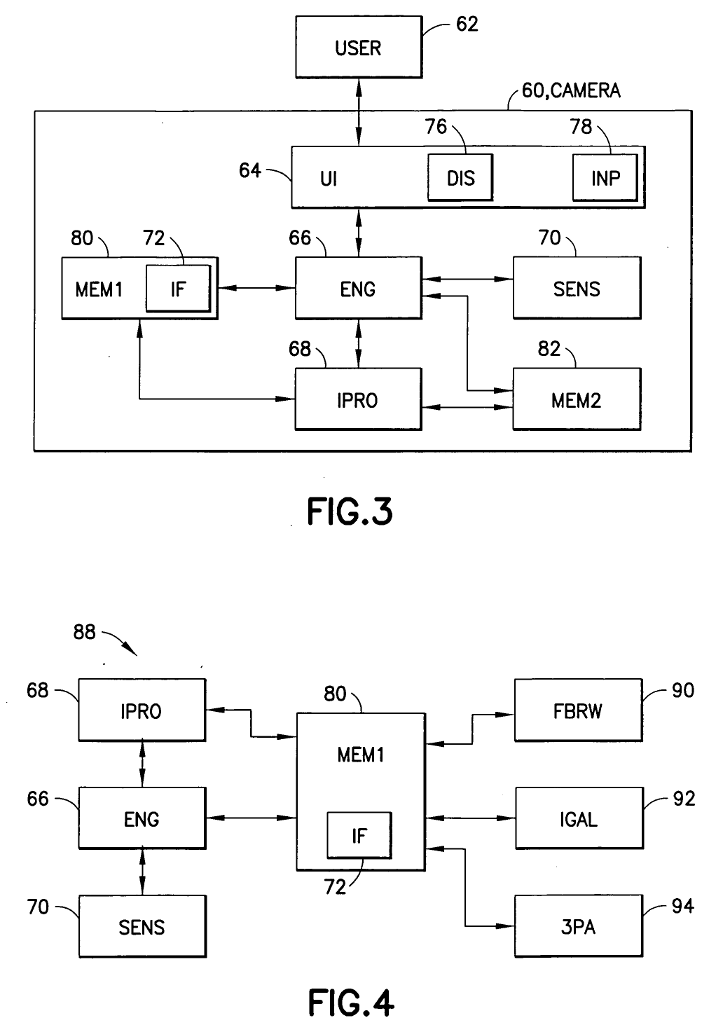

FIG. 3 shows a diagram of the components and control paths in an exemplary device (a camera 60) in accordance with aspects of the exemplary embodiments of the invention. A user 62 interacts with the camera 60 via a UI 64. The UI 64 is coupled to an engine (ENG) 66. The ENG 66 is coupled to an image processor (IPRO) 68 and a camera sensor (SENS) 70. As shown in FIG. 2, and in accordance with the exemplary embodiments of the invention, the UI 64, ENG 66 and SENS 70 generally operate in a foreground stage. In contrast, the IPRO 68 operates in a background stage. In some exemplary embodiments, the ENG 66 may be configured to implement (e.g., initiate, control) one or more background functions, such as the IPRO 68, in response to a condition being met (as noted above). In further exemplary embodiments, one or more of the UI 64, the ENG 66 and the IPRO 68 may be implemented by or comprise one or more data processors. Such one or more data processors may be coupled to one or more memories (MEM1 80, MEM2 82), such as a flash card, flash memory, RAM, hard drive and/or any other suitable internal, attached or external storage component or device.

While shown in FIG. 3 as only coupled to the ENG 66, in other exemplary embodiments the SENS 70 also may be coupled to and used by other processes as well. Furthermore, the camera 60 may comprise one or more additional functions, operations or components (software or hardware) that perform in the foreground stage and/or the background stage. In some exemplary embodiments, one or more processes may selectively execute in the foreground stage and/or the background stage.

The UI 64 provides an interface with the user 62 through which the camera 60 can receive user input (e.g., instructions, commands, a trigger to capture an image) and output information (e.g., via one or more lights or light emitting diodes, via a display screen, via an audio output, via a tactile output). As non-limiting examples, the UI 64 may comprise one or more of: a display screen, a touch pad, buttons, a keypad, a speaker, a microphone, an acoustic output, an acoustic input, or other input or output interface component(s). The UI 64 is generally controlled by the ENG 66. As shown in FIG. 2, the UI 64 includes a DIS 76 configured to show the preview image and at least one user input (INP) 78 configured to trigger image capture.

The ENG 66 communicates with the SENS 70 and, as an example, controls the viewfinder image processing. A preview image is processed and drawn to the DIS 76 (via the UI 64) by the ENG 66. When a still image is being captured, the ENG 66 requests still image data from the SENS 70 in raw format and saves the data to a memory (MEM1) 80 as an intermediate file (IF) 72. The ENG 66 processes and shows the preview image via the DIS 76. In some exemplary embodiments, the ENG 66 may send the information about the captured raw image (e.g., the IF 72) to the IPRO 68. Afterwards, the ENG 66 starts the viewfinder again (DIS 76) and is ready to capture a new still image (via SENS 70, in response to a user input via INP 78). In other exemplary embodiments, the IPRO 68 accesses the raw image data (the IF 72) from the MEM1 80 itself (i.e., without obtaining the raw image data/IF 72 via the ENG 66). Such an exemplary embodiment is shown in FIG. 3, where the IPRO 68 is coupled to the MEM1 80.

The IPRO 68 performs processing on the raw image data (the IF 72) in the background stage. If there is no captured raw image data or no unprocessed raw image data (no unprocessed intermediate files), the IPRO 68 waits until processing is needed. The IPRO 68 may output the processed image data back to the ENG 66 for storage (e.g., in the MEM1 80). In other exemplary embodiments, the IPRO 68 itself may attend to storage of the processed image data (e.g., in the MEM1 80). As non-limiting examples, the processed image data may be stored in the corresponding IF 72 or in a separate file or location.

Note that in other exemplary embodiments, the camera 60 may further comprise one or more additional memories or storage components (MEM2) 82. As a non-limiting example, the MEM2 may be used to store the processed image data while the MEM1 is used only to store the raw image data (the IF 72).

In the exemplary camera 60 of FIG. 3, background processing is controlled by the ENG 66. When the application starts, the three processes are initiated and the ENG 66 requests viewfinder images from the SENS 70. When the SENS 70 returns a new viewfinder image, the ENG 66 processes it and draws it to the DIS 76 (via UI 64). The ENG 66 also asks for a new viewfinder image (e.g., to update the currently-displayed viewfinder image). If the user 62 presses the capture key (INP 78), the ENG 66 requests a new still image from the SENS 70 in raw format and saves it to the MEM1 80 as an IF 72. In further exemplary embodiments, the ENG 66 also processes the preview image (of the captured image) and draws it to the DIS 76. In some exemplary embodiments, the ENG 66 may also send the raw image data to the IPRO 68 for processing. In other exemplary embodiments, the ENG 66 may inform the IPRO 68 that unprocessed raw image data (e.g., the IF 72) is present and ready for image processing by the IPRO 68. The viewfinder (DIS 76) is started again substantially immediately and a new viewfinder image is shown so that a new (another) still image can be captured.

In some exemplary embodiments, the operation of the IPRO 68 has a lower priority than other foreground operations (e.g., the ENG 66, the UI 64, the SENS 70). In further exemplary embodiments, the IPRO 68 may be capable of operating with a higher priority, for example, if there are no other operations (e.g., foreground operations) taking place. As a non-limiting example, this may occur if the camera 60 is turned off. In other exemplary embodiments, the ENG 66 or another component is configured to determine if the IPRO 68 should be operating and instructs accordingly. As is apparent, in some exemplary embodiments the foreground and the background stages are separated by priority, with the foreground operations taking priority over the background ones due to their visibility to the user.

FIG. 4 shows a further exemplary camera 88 incorporating features of the exemplary camera 60 shown in FIG. 3. In the exemplary camera 88 of FIG. 4, the MEM1 80 (which stores the IF 72) is not only accessible by the ENG 66 and the IPRO 68, but is also accessible by other components and programs. As non-limiting examples, in FIG. 4, the MEM1 80 (and thus the IF 72 and/or the processed image data) is further accessible by a file browser (FBRW) 90, an image gallery (IGAL) 92 and a third party application (3PA) 94. In such a manner, the IF 72 and/or the processed image data may be accessible by and/or used by additional components, programs and applications.

In further exemplary embodiments, at least one component, for example, the ENG 66, may have or oversee an image queue for captured images. When the IPRO 68 has finished processing an image, it starts to process the next image in the queue. If the user 62 closes the application and there are no more images to be processed, all processes are closed. In some exemplary embodiments, if there are more images to be processed (i.e., the queue is not empty), the ENG 66 and IPRO 68 do not shut down although the viewfinder is turned off (only the UI 64 is closed, i.e., due to the user closing the application). In this case, the IPRO 68 has more processing time and can process the images faster than when the viewfinder is turned on, for example, due to the reduced power consumption. When all images have been processed, the ENG 66 determines that there are no more images left (i.e., in the queue) and that the camera 60 is turned off(e.g., that the UI 64 has been closed), so the ENG 66 and the IPRO 68 are currently not needed (i.e., do not need to remain active) and are both closed.

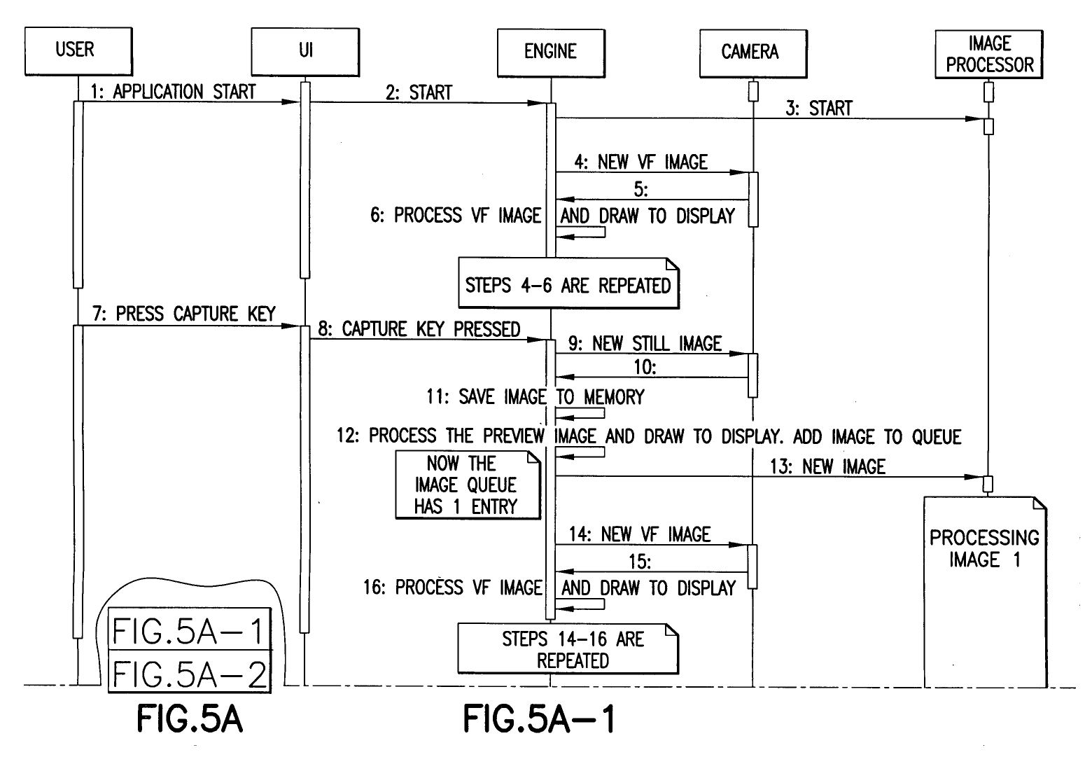

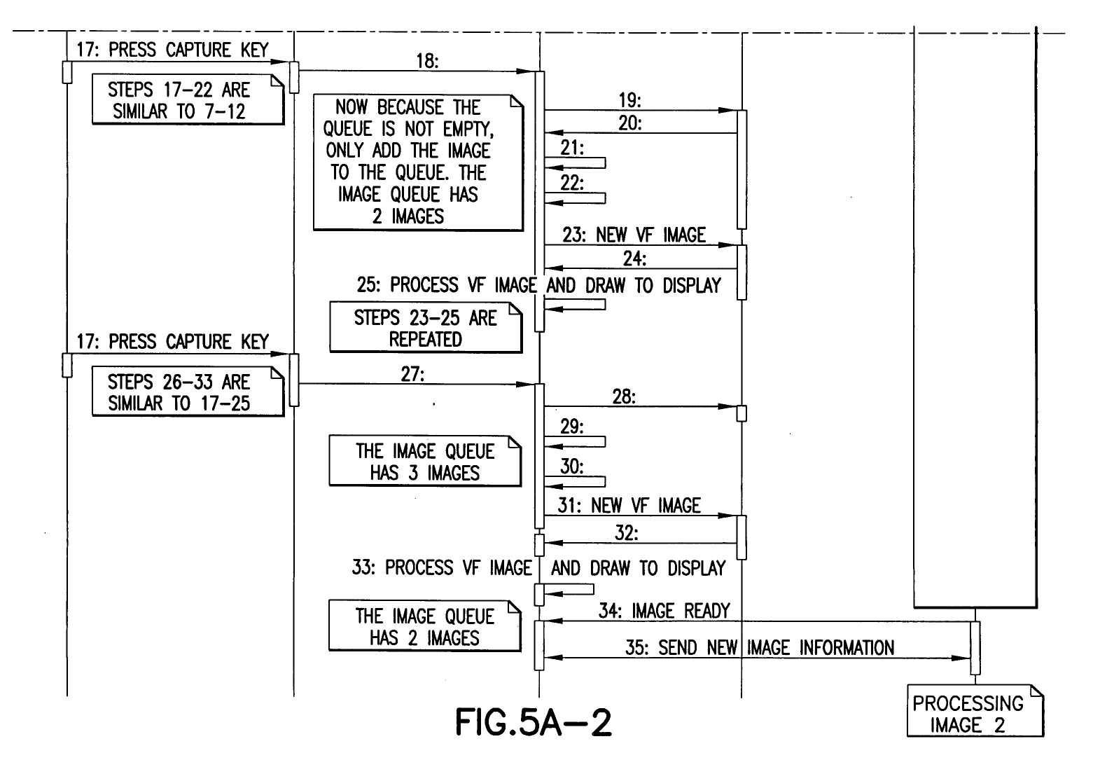

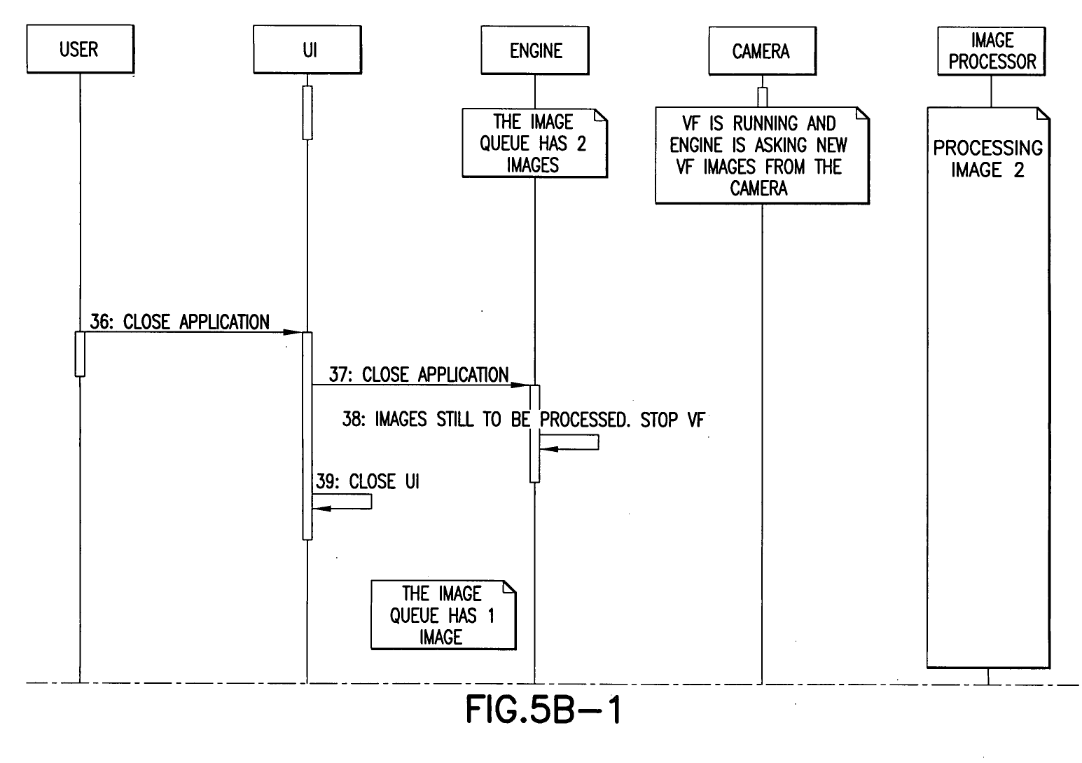

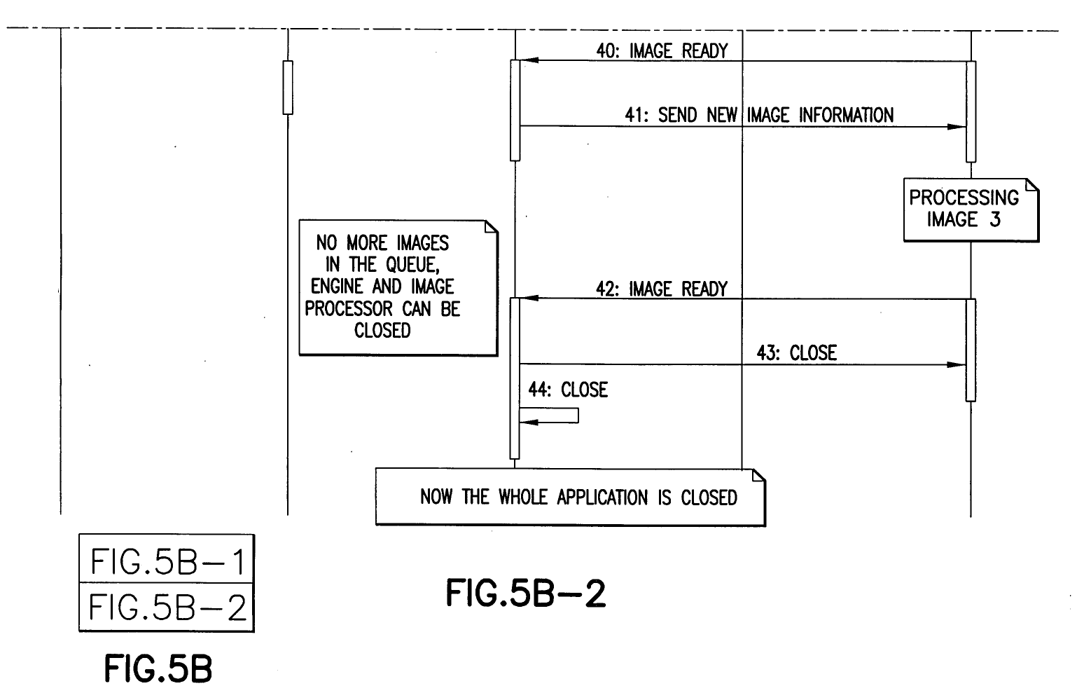

FIGS. 5A and 5B depict a flow diagram illustrating exemplary processes relating to an image queue and background processing for a camera in accordance with exemplary embodiments of the invention. In steps 1-3, the application is started which initializes the UI, engine and image processor. Steps 4-6 show the obtaining, processing and drawing of the viewfinder (VF) image on the display. Thus, steps 4-6 are repeated to produce a current VF image until a user presses the capture key (steps 7-8). Once the capture key is pressed (steps 7-8), a new still image is captured (steps 9-10) and saved to memory (step 11). A preview image is processed and drawn to the display for the captured image (step 12).

The captured image is also added to an image queue for processing (may also be referred to as a processing queue or an image processing queue). Since the captured image is the only image in the queue, the captured image is passed to the image processor for processing (step 13). Steps 14-16 show the obtaining, processing and drawing of the VF image on the display and, similar to steps 4-6, are repeated as necessary (e.g., until the capture key is pressed or until the camera application is turned off or disabled).

In steps 17-18, the capture key is pressed and a second still image is captured (steps 19-20) and saved to memory (step 21). A preview image is processed and drawn to the display for the second captured image (step 22). Since the second image is the second one in the queue, it will wait for processing. That is, once the image processor has finished processing the first image, it will begin processing the next image in the queue (in this case, the second image).). Steps 23-25 show the obtaining, processing and drawing of the VF image on the display and, similar to steps 4-6 and 14-16, are repeated as necessary.

In steps 26-27, the capture key is pressed a third time and a third still image is captured (step 28) and saved to memory (step 29). A preview image is processed and drawn to the display for the second captured image (step 30). At this point, the third image is third in the queue. Steps 31-33 show the obtaining, processing and drawing of the VF image on the display and, similar to steps 4-6, 14-16 and 23-25, are repeated as necessary.

At step 34, the image processor has finished processing the first image and signals the engine that it is ready for the next image in the queue (the second image). The engine sends the next image in the queue to the image processor for processing (step 35). After the second image is sent for processing, the queue now has two images left for processing (the second and third images, i.e., unprocessed images).

In steps 36-37, the user has closed the camera application. In response thereto, the VF operations are halted (i.e., the VF is stopped, step 38) and the UI is closed (step 39). However, the engine and image processor are not turned off since there are unprocessed images remaining in the queue, namely the second image (currently being processed by the image processor) and the third image. At step 40, the image processor has finished processing the second image and signals the engine. The third image, the last one in the queue, is sent to the image processor for processing (step 41). At step 42, the image processor has finished processing the third image. Since there are no remaining unprocessed images in the queue, the engine instructs the image processor to close down (step 43). Afterwards, the engine ceases operations and closes (step 44). Now, the whole application is closed and all captured images have been processed.

In further exemplary embodiments, a pause feature can be utilized. The pause feature reduces power consumption by enabling a user to temporarily stop using the camera module or SENS 70. In such a manner, the IPRO 68 may get more processing time and images can be processed faster. This will also further reduce power consumption since the camera module is not in use and processing is not needed for viewfinder frames (i.e., to repeatedly obtain, process and display a viewfinder image).

In some environments or systems it may be easier or more comfortable to utilize the pause function than close the application and restart it. An example of such a use is a situation where the user knows that he or she will be capturing images every now and then but not in the immediate future. If there are images to be processed in the queue, restarting the application may take a long time and the user may miss the scene which he or she desired to capture. By using the pause feature, it would be much faster to activate the application and be able to capture images again. The pause function may be particularly suitable, for example, with an auto-focus camera or a camera using a separate imaging processor since re-initialization of those components would not be needed.

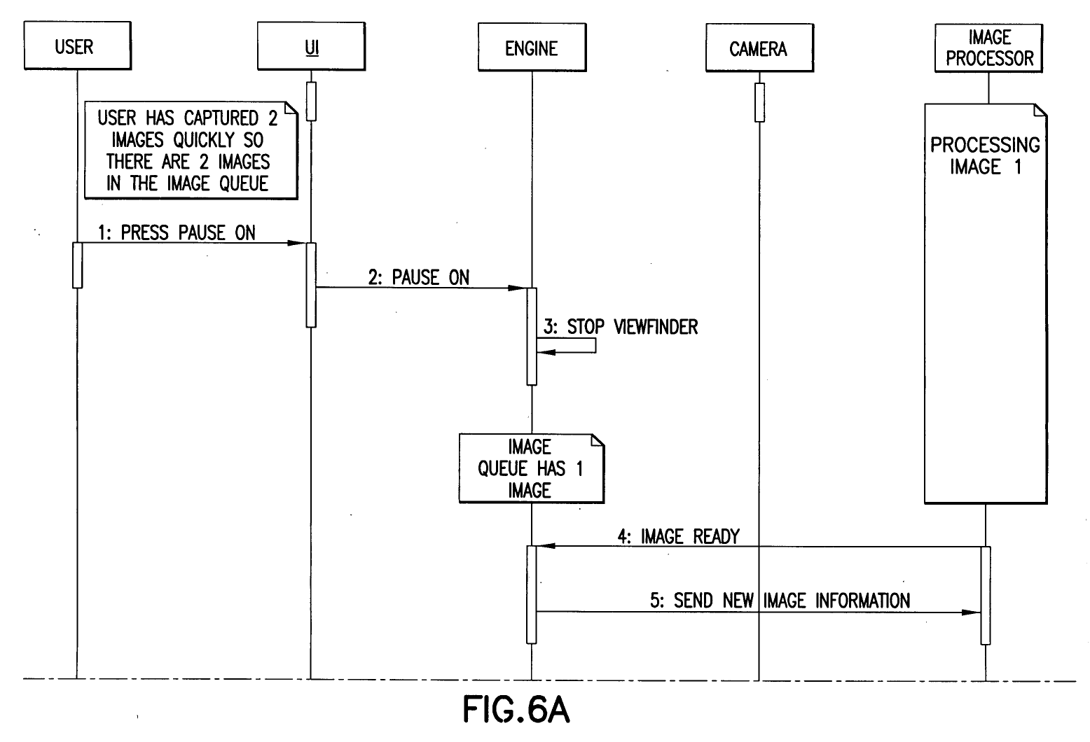

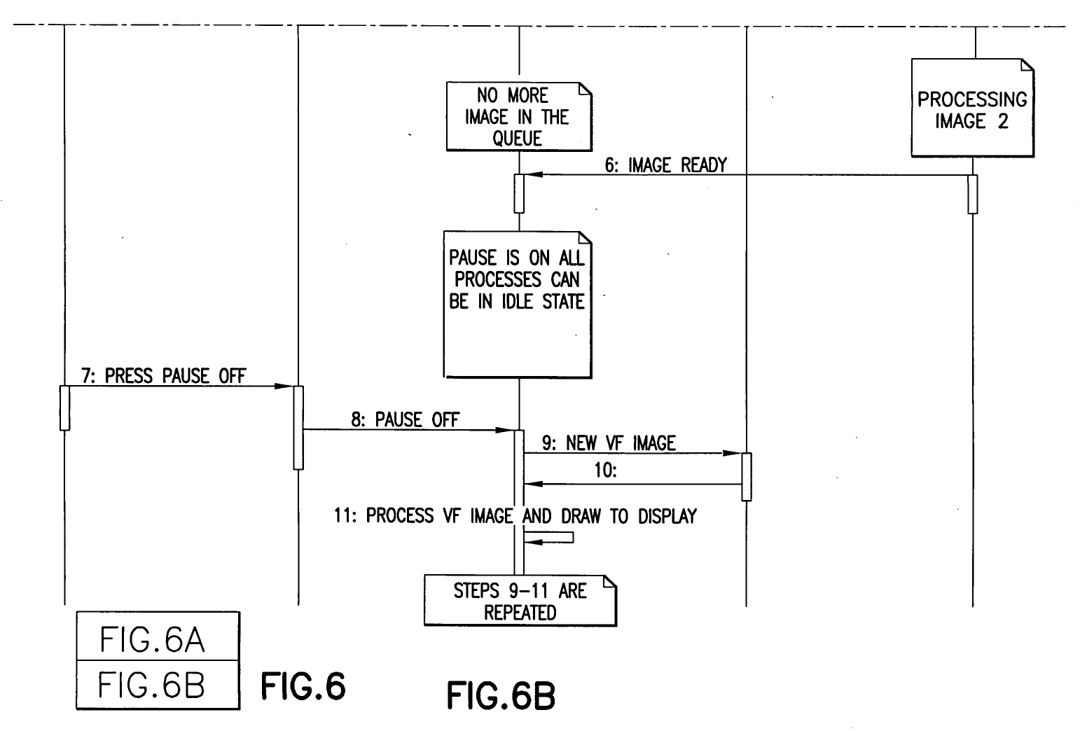

FIG. 6 depicts a flow diagram illustrating exemplary processes relating to a pause feature that may be implemented for a camera in accordance with exemplary embodiments of the invention. In FIG. 6, assume that the user has captured two images such that there are two images in the queue and the image processor is currently processing the first image (image 1), as shown in FIG. 6. At step 1, the user has activated the pause feature (Press Pause On) via the UI (step 2). In response thereto, the engine deactivates (stops) the VF (step 3), thus freeing up processing time for the image processor and reducing power consumption. The image processor acts as in FIG. 5, finishing the processing of the first image (step 4), receiving the second image for processing (step 5) and finishing the processing of the second image (step 6). Afterwards, all processes are in an idle state due the pause feature being on. At step 7, the user deactivates the pause feature (Press Pause Off) via the UI (step 8). As such, the engine manages the VF and has a current VF image obtained, processed and drawn to the display (steps 9-11).

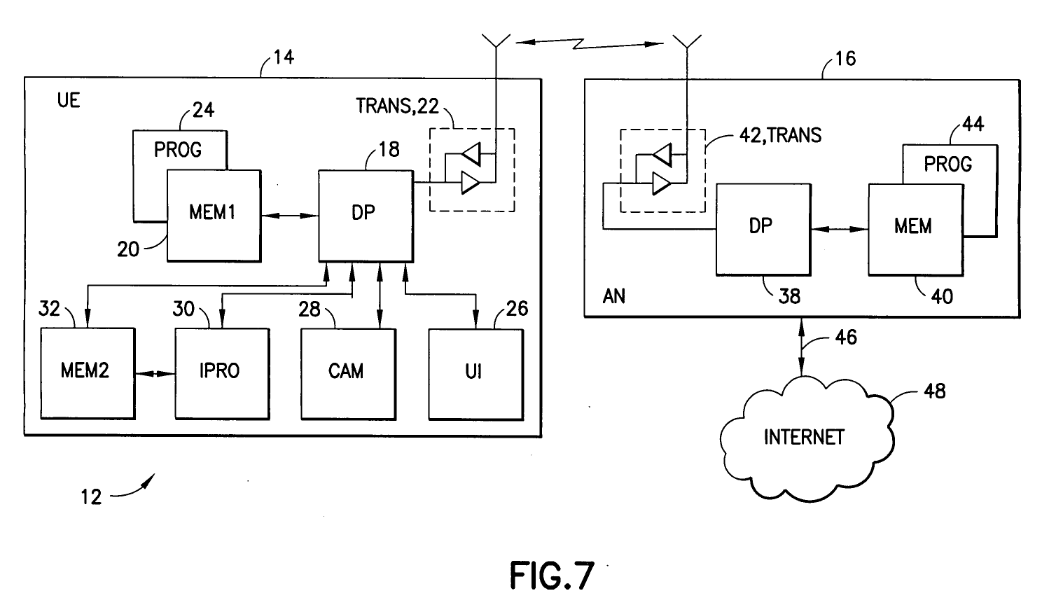

Reference is made to FIG. 7 for illustrating a simplified block diagram of various electronic devices that are suitable for use in practicing the exemplary embodiments of this invention. In FIG. 7, a wireless network 12 is adapted for communication with a user equipment (UE) 14 via an access node (AN) 16. The UE 14 includes a data processor (DP) 18, a memory (MEM1) 20 coupled to the DP 18, and a suitable RF transceiver (TRANS) 22 (having a transmitter (TX) and a receiver (RX)) coupled to the DP 18. The MEM1 20 stores a program (PROG) 24. The TRANS 22 is for bidirectional wireless communications with the AN 16. Note that the TRANS 22 has at least one antenna to facilitate communication. The DP 18 is also coupled to a user interface (UI) 26, a camera sensor (CAM) 28 and an image processor (IPRO) 30. The UI 26, CAM 28 and IPRO 30 operate as described elsewhere herein, for example, similar to the UI 64, SENS 70 and IPRO 68 of FIG. 3. In some exemplary embodiments, the UE 14 further comprises a second memory (MEM2) 32 coupled to the DP 18 and the IPRO 30. The MEM2 32 operates as described elsewhere herein, for example, similar to the MEM2 82 of FIG. 3.

The AN 16 includes a data processor (DP) 38, a memory (MEM) 40 coupled to the DP 38, and a suitable RF transceiver (TRANS) 42 (having a transmitter (TX) and a receiver (RX)) coupled to the DP 38. The MEM 40 stores a program (PROG) 44. The TRANS 42 is for bidirectional wireless communications with the UE 14. Note that the TRANS 42 has at least one antenna to facilitate communication. The AN 16 is coupled via a data path 46 to one or more external networks or systems, such as the internet 48, for example.

At least one of the PROGs 24, 44 is assumed to include program instructions that, when executed by the associated DP, enable the electronic device to operate in accordance with the exemplary embodiments of this invention, as discussed herein.

In general, the various exemplary embodiments of the UE 14 can include, but are not limited to, cellular phones, PDAs having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by one or more of the DPs 18, 38 of the UE 14 and the AN 16, or by hardware, or by a combination of software and hardware.

The MEMs 20, 32, 40 may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 18, 38 may be of any type suitable to the local technical environment, and may include one or more of general purpose computers, special purpose computers, microprocessors, DSPs and processors based on a multi-core processor architecture, as non-limiting examples.

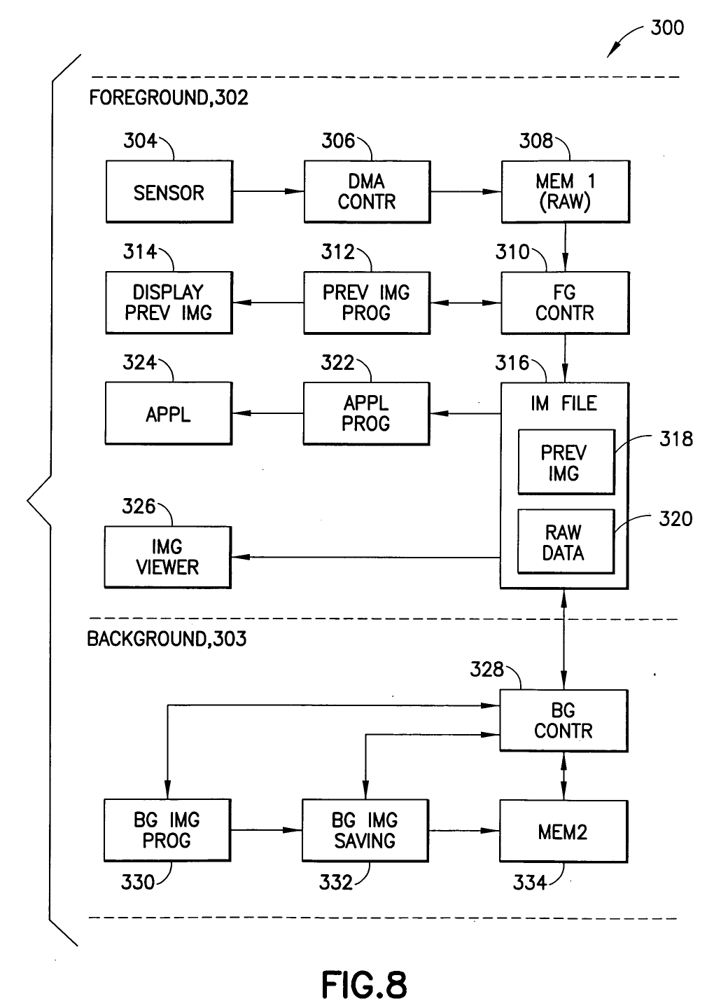

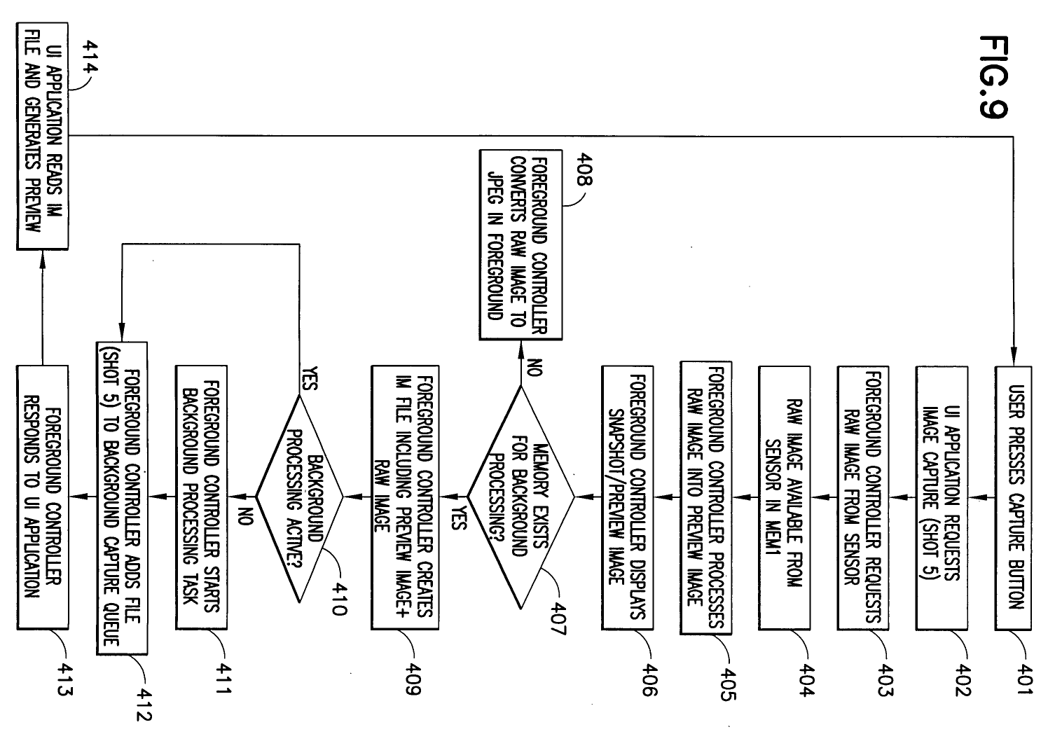

FIG. 8 depicts hardware and software interactions for an exemplary image capturing system 300 in accordance with exemplary embodiments of the invention. The components/processes are split into two categories, foreground 302 and background 303, which function as described elsewhere herein.

The sensor 304 captures image data, for example, in response to a user input (e.g., via a UI). The DMA controller (DMA CONTR) 306 assists with the storage of the raw image data on a memory (MEM1) 308. A foreground controller (FG CONTR) 310 accesses the raw data stored in the MEM1 308 and oversees various operations relating thereto. For example, the FG CONTR 310 reads the raw data and creates an intermediate (IM) file 316. In some exemplary embodiments, the FG CONTR 310 reads the raw data and oversees quick image processing that generates a preview image 312 corresponding to the raw image data. In further exemplary embodiments, the generated preview image is displayed 314.

In some exemplary embodiments, the IM file 316 may include not only the raw image data 320, but also the generated preview image 318. As an example, storing the preview image 318 in/with the IM file 316 enables an image-viewing application (IMG viewer) 326 to easily access the IM file 316 and display a corresponding preview image without having to perform any further processing.

In some exemplary embodiments, the preview image 318 is not stored in/with the IM file 316. In such cases, the IMG viewer 326 may still utilize the raw image data 320 to display the captured image, for example, by supporting the file format of the IM file 316. In some exemplary embodiments, the FG CONTR 310 generates the preview image.

The IM file 316 may also be processed (APPL PROC) 322 and/or used by one or more foreground applications (APPL) 324. As non-limiting examples, the APPL 324 and/or use may relate to: MMS, wallpaper, a screen saver, an image-sharing system or any other such system or program that allows for the use or communication of image data.

A background controller (BG CONTR) 328 also has access to the IM file 316 and oversees various background operations relating thereto. As non-limiting examples, the BG CONTR 328 may oversee operations relating to background image processing (BG IMG PROC) 330, background image saving (BG IMG saving) 332 and/or one or more queues for the BG IMG PROC 330.

The BG IMG PROC 330 processes the raw image data 320 in the IM file 316 and produces processed image data (e.g., a JPEG or BMP). The BG IMG saving 332 enables background saving of the raw image data, for example, to a non-volatile memory. As a non-limiting example, the task priority of the BG IMG saving 332 may be higher than the priority for the BG IMG PROC 330. Furthermore, in some exemplary embodiments, by allowing for saving of the raw image data to take place in the background 303, shot-to-shot time may be reduced even further and memory speed may have less of an impact. In further exemplary embodiments, a buffer is utilized in conjunction with the BG IMG saving 332. In other exemplary embodiments, a second memory (MEM2) 334 is utilized for storage of the IM file 316 and/or the processed image data. In further exemplary embodiments, the processed image data is included in a revised IM file and stored therewith.

In other exemplary embodiments, the exemplary system does no include the BG CONTR 328. Instead, the various background components and operations directly access the IM file 316 as further described herein. Note that as the options and choices available to a user of the system increase, it may be more desirable to include a BG CONTR 328 in order to control and process operations based on the user's selections.

In some exemplary embodiments, the IM file 316 is “reused.” That is, the processed image data also is saved to/in the IM file. In other exemplary embodiments, the IM file 316 is saved after the captured image data has been processed. In such a manner, the IM file 316 would include at least the raw image data and the processed image data. This may be useful, for example, should the user wish to subsequently re-process the raw image data with a more powerful system (e.g., to improve or alter the image processing). In some exemplary embodiments, the APPL 324 can access and make use of the BG CONTR 328 by using the stored IM file 316 (e.g., before or after the raw data 320 has been processed by the BG IMG PROC 330).

FIG. 9 depicts a flowchart illustrating one non-limiting example of a method for practicing the exemplary embodiments of this invention. A user presses the capture button to capture new image data (401). The UI application requests image capture for a fifth shot, shot 5 (402). The FG CONTR 310 requests raw image data from the sensor 304 (403). The raw image data from the sensor 304 is at least temporarily stored in MEM1 308 (404). The FG CONTR 310 processes the raw image data to obtain a preview image (405). The FG CONTR 310 oversees the display of the preview image (406). It is considered whether memory exists for background processing (407). If memory does not exist or there is an insufficient amount (No), the FG CONTR 310 performs the image processing in the foreground, for example, by converting the raw image data to a JPEG, and stores the same. If there is memory or a sufficient amount of memory (Yes), the FG CONTR 310 creates the IM file 316 which includes at least the raw image data 320 and, optionally, the preview image 318 (409).

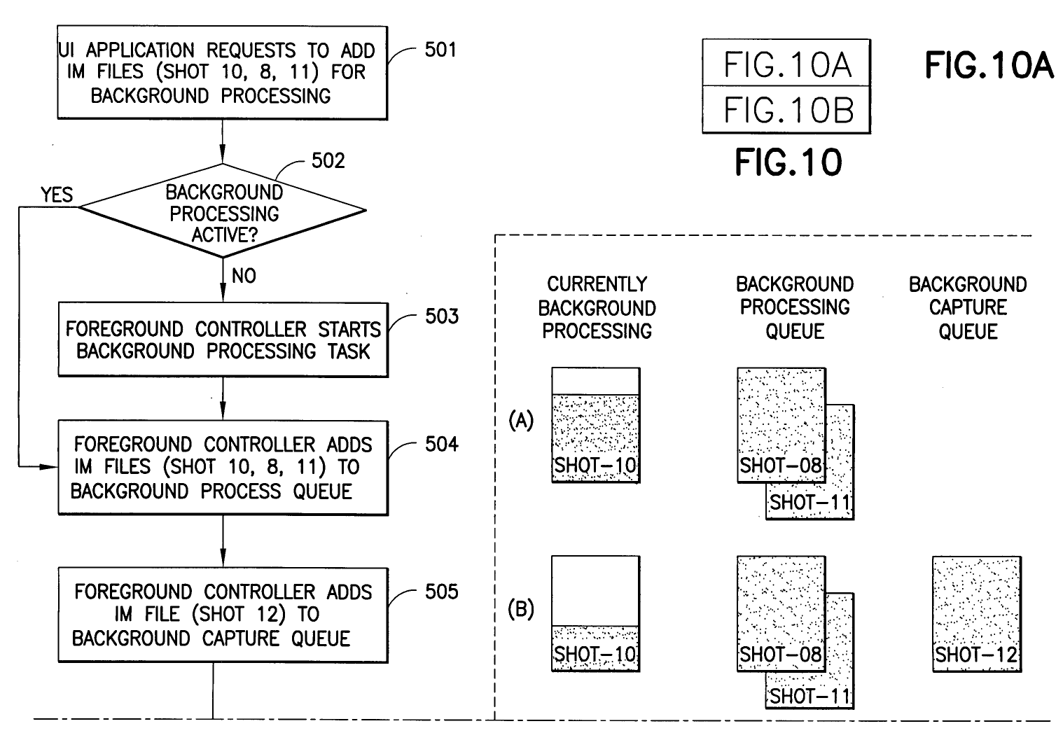

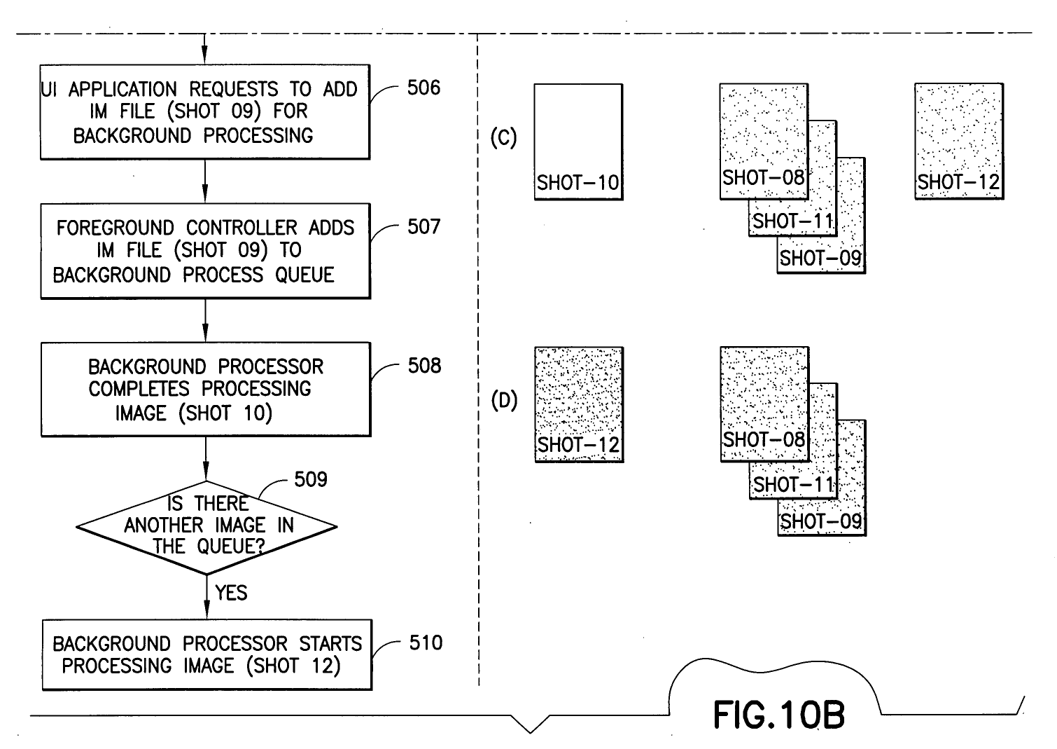

Next, it is considered whether background processing is active (410). If not (No), the FG CONTR 310 starts the background processing task (411). If background processing is active (Yes), the method does not perform this step (pass 411). Next, the FG CONTR 310 adds the file for the captured image data (shot 5) to the background capture queue (412). Generally, the shot is added to the back of the queue. However, in other exemplary embodiments, the shot may be inserted in the queue according to various priority concerns (e.g., see FIG. 10, discussed below). The FG CONTR 310 responds to the UI application by sending a message to signal that image capture, or at least the foreground stage of image capture, is complete (413). In some exemplary embodiments, instead of the FG CONTR 310 generating the preview image, the UI application reads the IM file 316 and generates the preview image (414). The method then returns to the beginning, in preparation for the capture of additional image data. Note that if the preview image were created by the FG CONTR 310 at step 409, then step 414 may be omitted.

FIG. 10 depicts a flowchart illustrating another non-limiting example of a method for practicing the exemplary embodiments of this invention. FIG. 10 also shows queues at various states with respect to the exemplary method. The UI application requests the addition of IM files for shots 10, 8 and 11 to the background processing queue (501). It is considered whether background processing is active (502). If not (No), the FG CONTR 310 starts the background processing task (503). If so (Yes), the background processing task is not started (pass 503). The FG CONTR 310 adds the IM files for shots 10, 8 and 11 to the background process queue (504). In this case, prior to the addition of shots 10, 8 and 11 (in that order), there were no IM files in the queue. As such, background processing for the IM file of shot 10, the first shot in the series (e.g., the one with the highest priority), is begun (A).

Next, assume that another image is to be captured (shot 12). The FG CONTR 310 adds the IM file for shot 12 to the background capture queue (505) (B). Note that shot 12 is given a higher priority than other shots in the queue (shots 8 and 11). As a non-limiting example, this may be due to a user's desire to immediately use the captured image (e.g., to share it with others). The UI application requests to add another IM file (for shot 9) to the background process queue (506). The FG CONTR 310 adds the IM file for shot 9 to the background process queue (507).

Next, assume that the background processing of shot 10 is completed (508) (C). It is considered whether there is another image in the queue (509). In this case, there are four images that still need to be processed with one of them, shot 12, having priority over the others. As such (Yes), background processing is begun for shot 12 (510) (D).

FIG. 10 depicts an exemplary embodiment utilizing two queues: a background process queue and a background capture queue. The two queues represent that there may be more than one type of priority among the unprocessed image data (i.e., unprocessed images). For example, for background image processing, newly-captured images (e.g., those in the background capture queue) may have a higher priority than earlier-captured images (e.g., those in the background process queue). Such earlier-captured, unprocessed images may remain, for example, due to power cycling of the device while there is an active queue of images to be processed. As another example, a user may insert a memory card containing unprocessed images. In such a manner, if more than one queue is used, there may be a first priority among the queues themselves and a second priority within the individual queues among the unprocessed images in each queue.

While shown in FIG. 10 with two queues, in other exemplary embodiments a different number of queues is used, such as only one queue or more than two queues, as non-limiting examples. If, for example, a single queue is used, the priority may define the order in which images are processed (e.g., with background image processing). In such a case, it would not matter where the raw image is from (e.g., the image sensor, captured earlier) nor how it arrived in the queue (e.g., a newly-captured image, captured earlier, captured earlier but the device was turned off), though, in some exemplary embodiments, such aspects could influence the position of one or more images in the queue.

FIG. 10 shows an example wherein shot 10 is processed prior to shots 8 and 11 and shot 12 is processed prior to shots 8, 11 and 9. In some exemplary embodiments, the order of processing is controlled and/or selected by the UI component, for example, in step 501. Once the order is chosen, the background process queue is populated to reflect that order. In some exemplary embodiments, new shots are added to the end of the queue. In other exemplary embodiments, new shots are processed before earlier shots. In some exemplary embodiments, the order/arrangement of shots in the queue can be re-processed (e.g., reorganized). In further exemplary embodiments, such reorganization can be controlled or implemented by a user. In other exemplary embodiments, a user may indicate that he or she wishes to have one or more unprocessed images processed as soon as possible. In such a case, the images may be processed in the foreground instead of the background.

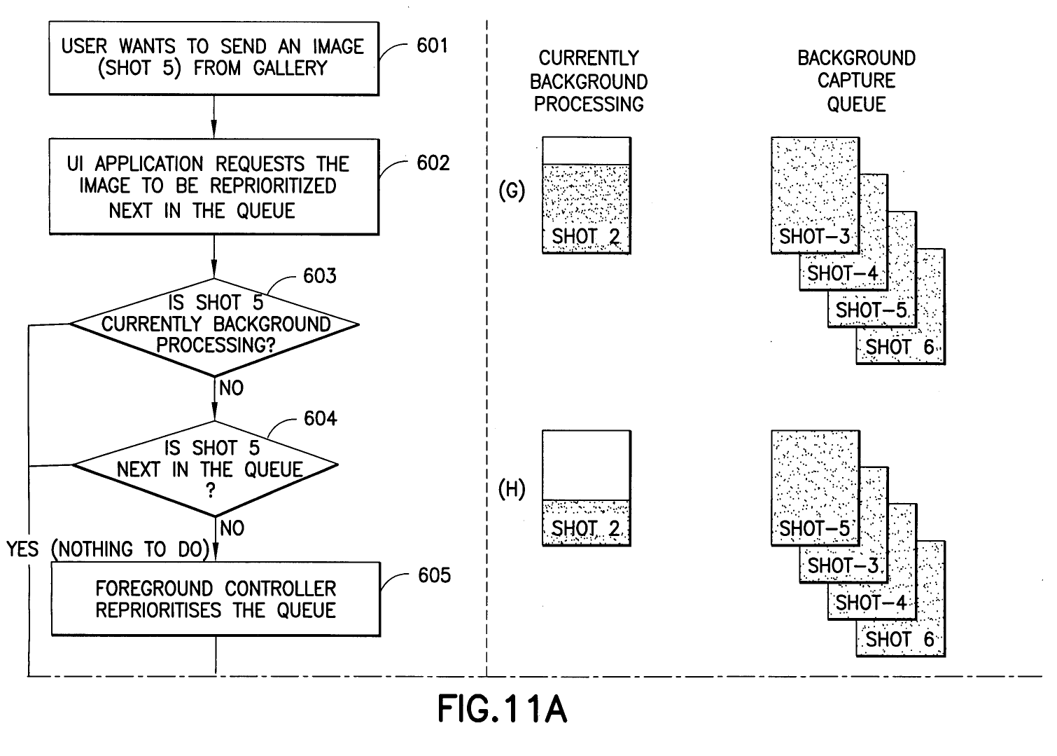

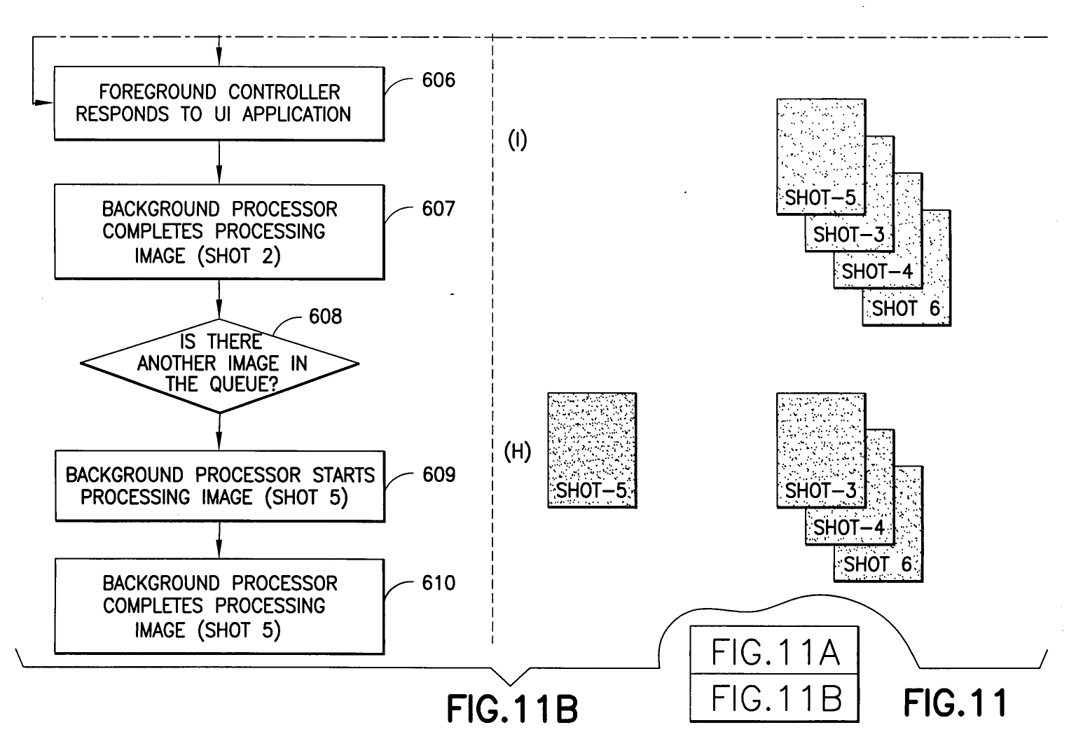

FIG. 11 depicts a flowchart illustrating another non-limiting example of a method for practicing the exemplary embodiments of this invention. FIG. 11 also shows queues at various states with respect to the exemplary method. For FIG. 11, assume that shot 2 is currently undergoing background image processing while shots 3, 4, 5 and 6 are in the background capture queue in that order (G).

A user wants to send an image (shot 5) from the user's gallery, for example, using an image-sharing application (601). The UI application requests the image (shot 5) be reprioritized as the next one in the queue (602). It is considered whether shot 5 is currently undergoing background processing (603). If so (Yes), the method passes to step 606. If not (No), it is considered whether shot 5 is the next one in the queue (604). If so (Yes), the method passes to step 606. If not (No), the FG CONTR 310 reprioritizes the queue, putting shot 5 as the next to be processed (605) (H). The FG CONTR 310 responds to the UI application by sending a message to signal that the reprioritization of an image to the next position in the queue is complete (606). This response does not signal the completion of associated processing.

Next, assume that the background processor has completed processing shot 2 (607) (I). It is considered whether there is another image in the queue (608). If so (Yes), the background processor starts processing the next image, shot 5 (609) (J). Once the background processor finishes processing shot 5 (610), steps 608-610 are repeated for successive, unprocessed images in the queue.

The exemplary embodiments of the invention may further be utilized in conjunction with non-mobile electronic devices or apparatus including, but not limited to, computers, terminals, gaming devices, music storage and playback appliances and internet appliances.

The exemplary embodiments of the invention provide improved usability and potentially reduced power consumption (e.g., using the pause feature). Furthermore, fast image previewing is provided substantially immediately after capturing an image by using the raw image data. In addition, the exemplary embodiments enable a shorter shot-to-shot time.

Exemplary embodiments of the invention provide advantages over conventional image capturing methods, computer programs, apparatus and systems by reducing one or more of the associated delays that are often problematic in prior art image capturing systems (e.g., cameras). For example, some exemplary embodiments improve on the shot-to-shot time by reducing the delay between sequential picture-taking or substantially eliminating pauses (e.g., for burst mode systems). Some exemplary embodiments reduce the user-perceived image processing time, for example, by enabling the viewfinder to display a picture more rapidly after a picture has been taken. In one non-limiting, exemplary embodiment, raw image data (i.e., substantially unprocessed) is stored in order to enable subsequent processing of the raw image data, for example, in parallel to other operations such as subsequent image capturing.

In additional exemplary embodiments of the invention, an intermediate file format with a fast creation time (e.g., due to minimal or no image processing) is utilized to reduce the shot-to-shot time. In further exemplary embodiments, the intermediate file may be subject to fast access so that it can be used for viewing or manipulation. In further exemplary embodiments, background image processing and/or conversion is performed on the intermediate file in order to produce processed image files and/or corresponding image files in other file formats, such as JPEG, as a non-limiting example.

Below are provided further descriptions of non-limiting, exemplary embodiments. The below-described exemplary embodiments are separately numbered for clarity and identification. This numbering should not be construed as wholly separating the below descriptions since various aspects of one or more exemplary embodiments may be practiced in conjunction with one or more other aspects or exemplary embodiments.

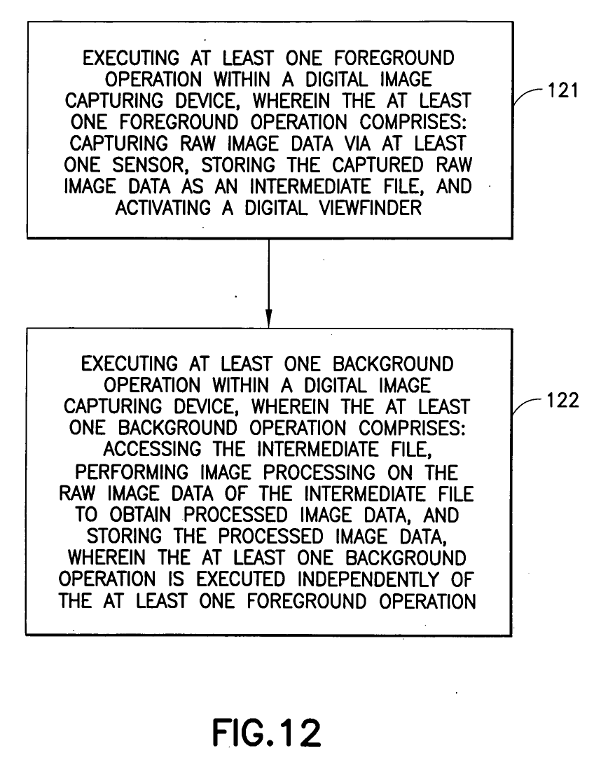

(1) As shown in FIG. 12, a method comprising: executing at least one foreground operation within a digital image capturing device, wherein the at least one foreground operation comprises: capturing raw image data via at least one sensor, storing the captured raw image data as an intermediate file, and activating a digital viewfinder (121); and executing at least one background operation within the digital image capturing device, wherein the at least one background operation comprises: accessing the intermediate file, performing image processing on the raw image data of the intermediate file to obtain processed image data, and storing the processed image data, wherein the at least one background operation is executed independently of the at least one foreground operation (122).

A method as above, wherein the at least one foreground operation further comprises: generating a preview image based on the captured raw image data; and displaying the generated preview image on the digital viewfinder. A method as in the previous, wherein the generated preview image is stored in the intermediate file with the captured raw image data. A method as in any above, further comprising: ceasing execution of the at least one foreground operation in response to a power off command, a close application command or a pause command; and continuing to execute said at least one background operation. A method as in any above, wherein activating the digital viewfinder comprises: obtaining current viewfinder image data, processing the obtained current viewfinder image data to obtain a current viewfinder image, and displaying the obtained current viewfinder image on the digital viewfinder, wherein the digital viewfinder is activated subsequent to displaying the generated preview image on the digital viewfinder.

A method as in any above, wherein the processed image data is stored in the intermediate file with the captured raw image data. A method as in any above, wherein the raw image data stored in the intermediate file comprises substantially lossless image data. A method as in any above, wherein the at least one foreground operation further comprises: capturing second raw image data via the at least one sensor, storing the captured second raw image data as a second intermediate file, and reactivating the digital viewfinder, wherein the second raw image data is captured while the at least one background operation is executing. A method as in the previous, wherein the at least one background operation further comprises a set of second background operations, said set of second background operations comprising: accessing the second intermediate file, performing image processing on the second raw image data of the second intermediate file to obtain processed second image data, and storing the processed second image data, wherein the set of second background operations are performed at a time that is not contemporaneous with capture of additional raw image data. A method as in any above, wherein the at least one background operation is executed concurrently with the at least one foreground operation. A method as in any above, wherein a background operation of the at least one background operation is selectively executed according to at least one of processing speed, storage speed, processor availability or storage availability. A method as in any above, wherein the digital image capturing device comprises a camera or a mobile device having camera functionality.

A method as in any above, wherein activating the digital viewfinder comprises: obtaining current viewfinder image data, processing the obtained current viewfinder image data to obtain a current viewfinder image, and displaying the obtained current viewfinder image on the digital viewfinder. A method as in any above, wherein the set of second background operations is selectively performed according to at least one of processing speed, storage speed, processor availability or storage availability. A method as in any above, wherein the set of second background operations is performed in response to a system event. A method as in any above, wherein the captured raw data is minimally processed prior to storage in the intermediate file. A method as in any above, wherein the method is implemented as a computer program.

(2) A program storage device readable by a machine, tangibly embodying a program of instructions executable by the machine for performing operations, said operations comprising: executing at least one foreground operation within a digital image capturing device, wherein the at least one foreground operation comprises: capturing raw image data via at least one sensor, storing the captured raw image data as an intermediate file, and activating a digital viewfinder (121); and executing at least one background operation within the digital image capturing device, wherein the at least one background operation comprises: accessing the intermediate file, performing image processing on the raw image data of the intermediate file to obtain processed image data, and storing the processed image data, wherein the at least one background operation is executed independently of the at least one foreground operation (122).

A program storage device as above, wherein the at least one foreground operation further comprises: generating a preview image based on the captured raw image data; and displaying the generated preview image on the digital viewfinder. A program storage device as in the previous, wherein the generated preview image is stored in the intermediate file with the captured raw image data. A program storage device as in any above, said operations further comprising: ceasing execution of the at least one foreground operation in response to a power off command, a close application command or a pause command; and continuing to execute said at least one background operation. A program storage device as in any above, wherein activating the digital viewfinder comprises: obtaining current viewfinder image data, processing the obtained current viewfinder image data to obtain a current viewfinder image, and displaying the obtained current viewfinder image on the digital viewfinder, wherein the digital viewfinder is activated subsequent to displaying the generated preview image on the digital viewfinder.

A program storage device as in any above, wherein the processed image data is stored in the intermediate file with the captured raw image data. A program storage device as in any above, wherein the raw image data stored in the intermediate file comprises substantially lossless image data. A program storage device as in any above, wherein the at least one foreground operation further comprises: capturing second raw image data via the at least one sensor, storing the captured second raw image data as a second intermediate file, and reactivating the digital viewfinder, wherein the second raw image data is captured while the at least one background operation is executing. A program storage device as in the previous, wherein the at least one background operation further comprises a set of second background operations, said set of second background operations comprising: accessing the second intermediate file, performing image processing on the second raw image data of the second intermediate file to obtain processed second image data, and storing the processed second image data, wherein the set of second background operations are performed at a time that is not contemporaneous with capture of additional raw image data. A program storage device as in any above, wherein the at least one background operation is executed concurrently with the at least one foreground operation. A program storage device as in any above, wherein a background operation of the at least one background operation is selectively executed according to at least one of processing speed, storage speed, processor availability or storage availability. A program storage device as in any above, wherein the digital image capturing device comprises a camera or a mobile device having camera functionality.

A program storage device as in any above, wherein activating the digital viewfinder comprises: obtaining current viewfinder image data, processing the obtained current viewfinder image data to obtain a current viewfinder image, and displaying the obtained current viewfinder image on the digital viewfinder. A program storage device as in any above, wherein the set of second background operations is selectively performed according to at least one of processing speed, storage speed, processor availability or storage availability. A program storage device as in any above, wherein the set of second background operations is performed in response to a system event. A program storage device as in any above, wherein the captured raw data is minimally processed prior to storage in the intermediate file. A program storage device as in any above, wherein the machine comprises the digital image capturing device.

(3) An apparatus comprising: at least one sensor (70) configured to capture raw image data; a first memory (80) configured to store the raw image data; a display (76) configured to display at least one of a preview image for the raw image data or a viewfinder image; an image processor (68) configured to process the stored raw image data to obtain processed image data; and a second memory (82) configured to store the processed image data, wherein the image processor (68) is configured to operate independently of the at least one sensor (70) and the display (76).

An apparatus as above, further comprising: a controller configured to control operation of the at least one sensor, the first memory, and the display. An apparatus as in any above, wherein the raw image data is stored on the first memory in an intermediate file. An apparatus as in any above, wherein the intermediate file further comprises at least one of the preview image or the processed image data. An apparatus as in any above, wherein the preview image for the raw image data is displayed on the display subsequent to capture of the raw image data by the at least one sensor. An apparatus as in any above, wherein the at least one sensor is further configured to capture second raw image data while the image processor is processing the raw image data. An apparatus as in any above, wherein the image processor is further configured to process the raw image data at a time that is not contemporaneous with capture of additional raw image data by the at least one sensor.

An apparatus as in any above, wherein the image processor is selectively active according to at least one of processing speed, storage speed, processor availability or storage availability. An apparatus as in any above, wherein the first memory comprises the second memory. An apparatus as in any above, wherein the apparatus comprises a digital image capturing device. An apparatus as in the previous, wherein the digital image capturing device comprises a camera or a mobile device having camera functionality.

An apparatus as in any above, wherein the apparatus comprises a cellular phone having camera functionality. An apparatus as in any above, wherein the raw image data stored on the first memory comprises substantially lossless image data. An apparatus as in any above, further comprising: a processor configured to generate the preview image based on the captured raw image data. An apparatus as in any above, wherein the display is configured to display the preview image for the raw image data subsequent to the at least one sensor capturing the raw image data. An apparatus as in the previous, wherein the display is configured to display the viewfinder image subsequent to displaying the preview image for the raw image data. An apparatus as in any above, wherein the image processor is configured to process the stored raw image data to obtain the processed image data in response to a system event. An apparatus as in any above, further comprising: a processor configured to minimally process the raw image data prior to storage of the raw image data on the first memory.

(4) An apparatus comprising: means for capturing (70) raw image data; first means for storing the raw image data (80); means for displaying (76) at least one of a preview image for the raw image data or a viewfinder image; means for processing (68) the stored raw image data to obtain processed image data; and second means for storing (82) the processed image data, wherein the means for processing (68) is configured to operate independently of the means for capturing (70) and the means for displaying (76).

An apparatus as above, further comprising: means for controlling operation of the means for capturing, the first means for storing, and the means for displaying. An apparatus as in any above, wherein the raw image data is stored on the first means for storing in an intermediate file. An apparatus as in any above, wherein the intermediate file further comprises at least one of the preview image or the processed image data. An apparatus as in any above, wherein the preview image for the raw image data is displayed on the means for displaying subsequent to capture of the raw image data by the means for capturing. An apparatus as in any above, wherein the means for capturing is further for capturing second raw image data while the means for processing is processing the raw image data. An apparatus as in any above, wherein the means for processing is further for processing the raw image data at a time that is not contemporaneous with capture of additional raw image data by the means for capturing.

An apparatus as in any above, wherein the means for processing is selectively active according to at least one of processing speed, storage speed, processor availability or storage availability. An apparatus as in any above, wherein the first means for storing comprises the second means for storing. An apparatus as in any above, wherein the apparatus comprises a digital image capturing device. An apparatus as in the previous, wherein the digital image capturing device comprises a camera or a mobile device having camera functionality. An apparatus as in any above, wherein the means for capturing comprises at least one sensor, the first means for storing comprises a first memory, the means for displaying comprises a display, the means for processing comprises at least one image processor and the second means for storing comprises a second memory.

An apparatus as in any above, wherein the apparatus comprises a cellular phone having camera functionality. An apparatus as in any above, wherein the raw image data stored on the first means for storing comprises substantially lossless image data. An apparatus as in any above, further comprising: means for generating the preview image based on the captured raw image data. An apparatus as in the previous, wherein the means for generating comprises a processor. An apparatus as in any above, wherein the means for displaying is further for displaying the preview image for the raw image data subsequent to the means for capturing capturing the raw image data. An apparatus as in the previous, wherein the means for displaying is further for displaying the viewfinder image subsequent to displaying the preview image for the raw image data. An apparatus as in any above, wherein the means for processing is configured to process the stored raw image data to obtain the processed image data in response to a system event. An apparatus as in any above, further comprising: means for minimally processing the raw image data prior to storage of the raw image data on the first memory. An apparatus as in the previous, wherein the means for minimally processing comprises a processor or an image processor.

(5) An apparatus comprising: sensing circuitry configured to capture raw image data; first storage circuitry configured to store the raw image data; display circuitry configured to display at least one of a preview image for the raw image data or a viewfinder image; processing circuitry configured to process the stored raw image data to obtain processed image data; and second storage circuitry configured to store the processed image data, wherein the processing circuitry is configured to operate independently of the sensing circuitry and the display circuitry. An apparatus as in the previous, wherein one or more of the circuitries are embodied in an integrated circuit. An apparatus as in any above, further comprising one or more additional aspects of the exemplary embodiments of the invention as further described herein.

(6) An apparatus comprising: means for executing at least one foreground operation (310) within a digital image capturing device, wherein the at least one foreground operation comprises: capturing raw image data via at least one sensor, storing the captured raw image data as an intermediate file, and activating a digital viewfinder; and means for executing at least one background operation (328) within the digital image capturing device, wherein the at least one background operation comprises: accessing the intermediate file, performing image processing on the raw image data of the intermediate file to obtain processed image data, and storing the processed image data, wherein the at least one background operation is executed independently of the at least one foreground operation. An apparatus as in the previous, wherein the means for executing at least one foreground operation comprises a first processor and the means for executing at least one background operation comprises a second processor. An apparatus as in any above, further comprising one or more additional aspects of the exemplary embodiments of the invention as further described herein.

(7) An apparatus comprising: first execution circuitry configured to execute at least one foreground operation within a digital image capturing device, wherein the at least one foreground operation comprises: capturing raw image data via at least one sensor, storing the captured raw image data as an intermediate file, and activating a digital viewfinder; and second execution circuitry configured to execute at least one background operation within the digital image capturing device, wherein the at least one background operation comprises: accessing the intermediate file, performing image processing on the raw image data of the intermediate file to obtain processed image data, and storing the processed image data, wherein the at least one background operation is executed independently of the at least one foreground operation. An apparatus as in the previous, wherein one or more of the circuitries are embodied in an integrated circuit. An apparatus as in any above, further comprising one or more additional aspects of the exemplary embodiments of the invention as further described herein.

The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

The exemplary embodiments of the invention, as discussed above and as particularly described with respect to exemplary methods, may also be implemented as a program storage device readable by a machine, tangibly embodying a program of instructions executable by the machine for performing operations, said operations comprising steps of utilizing the exemplary embodiments or steps of the method.

As utilized and described herein, the performance of a first set of operations is considered to be contemporaneous with the performance of a second set of operations if a first operations is executed or being executed while a second operation is executed or being executed. Relatedly, performance of operations for the two sets is considered not to be contemporaneous if a second operation is not performed while a first operation is executed or being executed.

It should be noted that the terms “connected,” “coupled,” or any variant thereof, mean any connection or coupling, either direct or indirect, between two or more elements (e.g., software elements, hardware elements), and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

While the exemplary embodiments have been described above in the context of a camera or camera system, it should be appreciated that the exemplary embodiments of this invention are not limited for use with only this one particular type of system, and that they may be used to advantage in other systems that contain a camera or implement digital still image capturing system.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The exemplary embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of the non-limiting and exemplary embodiments of this invention.

Furthermore, some of the features of the preferred embodiments of this invention could be used to advantage without the corresponding use of other features. As such, the foregoing description should be considered as merely illustrative of the principles, teachings and exemplary embodiments of this invention, and not in limitation thereof.

What is claimed is:

1. A method comprising:
executing at least one foreground operation within a digital image capturing device,
wherein the at least one foreground operation comprises: capturing raw image data via at least one sensor, storing the captured raw image data as an intermediate file, and activating a digital viewfinder; and
executing at least one background operation within the digital image capturing device,
wherein the at least one background operation comprises: accessing the intermediate file, performing image processing on the raw image data of the intermediate file to obtain processed image data, and storing the processed image data,
wherein the at least one background operation is executed independently of the at least one foreground operation.

2. A method as in claim 1, wherein the at least one foreground operation further comprises: generating a preview image based on the captured raw image data; and displaying the generated preview image on the digital viewfinder.

3. A method as in claim 2, wherein the generated preview image is stored in the intermediate file with the captured raw image data.

4. A method as in claim 2, further comprising: ceasing execution of the at least one foreground operation in response to a power off command, a close application command or a pause command; and continuing to execute said at least one background operation.

5. A method as in claim 2, wherein activating the digital viewfinder comprises: obtaining current viewfinder image data, processing the obtained current viewfinder image data to obtain a current viewfinder image, and displaying the obtained current viewfinder image on the digital viewfinder, wherein the digital viewfinder is activated subsequent to displaying the generated preview image on the digital viewfinder.

6. A method as in claim 1, wherein the processed image data is stored in the intermediate file with the captured raw image data.

7. A method as in claim 1, wherein the raw image data stored in the intermediate file comprises substantially lossless image data.

9. A method as in claim 1, wherein the at least one foreground operation further comprises: capturing second raw image data via the at least one sensor, storing the captured second raw image data as a second intermediate file, and reactivating the digital viewfinder, wherein the second raw image data is captured while the at least one background operation is executing.

10. A method as in claim 9, wherein the at least one background operation further comprises a set of second background operations, said set of second background operations comprising: accessing the second intermediate file, performing image processing on the second raw image data of the second intermediate file to obtain processed second image data, and storing the processed second image data, wherein the set of second background operations are performed at a time that is not contemporaneous with capture of additional raw image data.

11. A method as in claim 1, wherein the at least one background operation is executed concurrently with the at least one foreground operation.

12. A method as in claim 1, wherein a background operation of the at least one background operation is selectively executed according to at least one of processing speed, storage speed, processor availability or storage availability.

13. A method as in claim 1, wherein the digital image capturing device comprises a camera or a mobile device having camera functionality.

14. A program storage device readable by a machine, tangibly embodying a program of instructions executable by the machine for performing operations, said operations comprising:
executing at least one foreground operation within a digital image capturing device,
wherein the at least one foreground operation comprises: capturing raw image data via at least one sensor, storing the captured raw image data as an intermediate file, and activating a digital viewfinder; and
executing at least one background operation within the digital image capturing device,
wherein the at least one background operation comprises: accessing the intermediate file, performing image processing on the raw image data of the intermediate file to obtain processed image data, and storing the processed image data,
wherein the at least one background operation is executed independently of the at least one foreground operation.

15. A program storage device as in claim 14, wherein the at least one foreground operation further comprises: generating a preview image based on the captured raw image data; and displaying the generated preview image on the digital viewfinder.

16. A program storage device as in claim 15, wherein the generated preview image is stored in the intermediate file with the captured raw image data.

17. A program storage device as in claim 15, wherein activating the digital viewfinder comprises: obtaining current viewfinder image data, processing the obtained current viewfinder image data to obtain a current viewfinder image, and displaying the obtained current viewfinder image on the digital viewfinder, wherein the digital viewfinder is activated subsequent to displaying the generated preview image on the digital viewfinder.

18. A program storage device as in claim 14, wherein the processed image data is stored in the intermediate file with the captured raw image data.

19. A program storage device as in claim 14, wherein the at least one foreground operation further comprises: capturing second raw image data via the at least one sensor, storing the captured second raw image data as a second intermediate file, and reactivating the digital viewfinder, wherein the second raw image data is captured while the at least one background operation is executing.

20. A program storage device as in claim 19, wherein the at least one background operation further comprises a set of second background operations, said set of second background operations comprising: accessing the second intermediate file, performing image processing on the second raw image data of the second intermediate file to obtain processed second image data, and storing the processed second image data, wherein the set of second background operations are performed at a time that is not contemporaneous with capture of additional raw image data.

21. A program storage device as in claim 14, wherein the at least one background operation is executed concurrently with the at least one foreground operation.

22. A program storage device as in claim 14, wherein a background operation of the at least one background operation is selectively executed according to at least one of processing speed, storage speed, processor availability or storage availability.

23. A program storage device as in claim 14, wherein the machine comprises a digital image capturing device.

24. A program storage device as in claim 23, wherein the digital image capturing device comprises a camera or a mobile device having camera functionality.

25. An apparatus comprising:
at least one sensor configured to capture raw image data;
a first memory configured to store the raw image data;
a display configured to display at least one of a preview image for the raw image data or a viewfinder image;
an image processor configured to process the stored raw image data to obtain processed image data; and
a second memory configured to store the processed image data,
wherein the image processor is configured to operate independently of the at least one sensor and the display.

26. An apparatus as in claim 25, further comprising: a controller configured to control operation of the at least one sensor, the first memory, and the display.

27. An apparatus as in claim 25, wherein the raw image data is stored on the first memory in an intermediate file.

28. An apparatus as in claim 27, wherein the intermediate file further comprises at least one of the preview image or the processed image data.

29. An apparatus as in claim 25, wherein the preview image for the raw image data is displayed on the display subsequent to capture of the raw image data by the at least one sensor.

30. An apparatus as in claim 25, wherein the at least one sensor is further configured to capture second raw image data while the image processor is processing the raw image data.

31. An apparatus as in claim 25, wherein the image processor is further configured to process the raw image data at a time that is not contemporaneous with capture of additional raw image data by the at least one sensor.

32. An apparatus as in claim 25, wherein the image processor is selectively active according to at least one of processing speed, storage speed, processor availability or storage availability.

33. An apparatus as in claim 25, wherein the first memory comprises the second memory.

34. An apparatus as in claim 25, wherein the apparatus comprises a digital image capturing device.

35. An apparatus as in claim 34, wherein the digital image capturing device comprises a camera or a mobile device having camera functionality.
